(19) United States
(12) Patent Application Publication
(10) Pub. No.: US 2002/0044304 A1
(43) Pub. Date: Apr. 18, 2002

(54) IMAGE READING DEVICE AND METHOD

(76) Inventor: TORU OCHIAI, KASHIWA-SHI (JP)

Correspondence Address: OLIFF & BERRIDGE, P O BOX 19928, ALEXANDRIA, VA, 22320

(21) Appl. No.: 08/789,989

(22) Filed: Jan. 28, 1997

(30) Foreign Application Priority Data
Mar. 14, 1996 (JP) 8-058033
Jul. 10, 1996 (JP) 8-180681

(51) Int. Cl. H04N 1/04

(52) U.S. Cl. 358/450

(57) ABSTRACT

A photographic data input device inputs photographic data of a film that occurs at the time of photography and outputs a photographic data signal. An image reading device reads the image on the film, and a control device establishes the reading conditions of the image reading device based upon the photographic data signal.

### FIELD OF THE INVENTION

The present application relates to an image reading device and method for reading at least one image of a film.

### Description of Related Art

As is widely known, a film image reading device is used to read an image which is on a film original of, for example, 35 mm film. With an image reading device, because the exposure conditions and so forth of the film are not fixed, a pre-scan is performed with fixed conditions. Generally, the establishment of reading conditions that are thought to be optimal for the original is performed considering the measurement taken of the optical density distribution of the original.

However, with reading devices of the prior art, conditions were set that at the time of reading were thought to be optimal for the original, but with no consideration of the data at the time of photography.

For example, with regard to the aspect ratio (comparing vertical and horizontal), the reading device of the prior art was unable to distinguish whether an image was photographed with a so-called panorama size (vertical 1: horizontal 3) or by a so-called high vision size (vertical 9: horizontal 16). It is especially difficult to distinguish from the image when there is no masking at the time of photography, because the image on the film is exactly the same.

For this purpose, for example, as is shown in FIG. 15, the sun 42 is in the top portion of the screen when photographing the subject 41 in panorama size. Even if the photographer shoots without including the sun within the dotted line P which indicates the frame of the panorama size, when there is no masking, the sun 42 actually is photographed on the film. On the other hand, the pre-scan is based on the algorithm shown in FIG. 16. This searches the brightest point of the selected image and sets the exposure conditions to the most appropriate level.

When pre-scanning an image such as that in FIG. 15 with this type of algorithm, it searches the for the brightest point within the full area of photography, and determines that the portion of the sun 42 is the brightest point. Heretofore, because of this, even though it is supposed to use the value of the brightest point within the area shown by the dotted-line P, because there is no data establishing it as a panorama size, it is unable to obtain the most appropriate exposure for the entire area with the final scan.

In addition, because it is impossible to know from the image on the film if it is over-exposed or under-exposed at the time of photography, it is impossible to obtain the most appropriate exposure with the final scan.

Due to the aforementioned problems, it apparent that appropriate image reading cannot be obtained for the film image, thereby creating a problem where a high quality image cannot be produced.

### SUMMARY OF THE INVENTION

The present invention amply considers these problems and has one objective of providing a device that has the ability to read an image of higher quality based upon the data at the time of photography.

To achieve the aforementioned objective, the device according to the present invention has been endowed with a photographic data input device that inputs photographic data of a film that occurs at the time of photography and outputs a photographic data signal; an image reading device that reads the image on the film; and a controller that establishes the reading conditions of the image device based upon the photographic data signal.

These and other salient features of the invention will be described in or apparent from the following detailed description of preferred embodiments.

### BRIEF DESCRIPTION OF THE DRAWINGS

The invention will be described in detail with reference to the following drawings in which:

FIG. 1 is a block diagram illustrating a device according to one embodiment of the present invention;

FIG. 2 illustrates film usable with the device according to one embodiment of the present invention;

FIG. 3 is a flow chart illustrating pre-scanning action of the device according to one embodiment of the present invention;

FIG. 4 is a flow chart illustrating the pre-scanning action of the device according to one embodiment of the present invention;

FIG. 5 illustrates a film in use with the device according to one embodiment of the present invention;

FIG. 6 illustrates a histogram;

FIG. 7 illustrates a histogram that corresponds to the change of sensor storage time according to one embodiment of the present invention;

FIG. 8 illustrates gradation conversion properties of a Look Up Table (LUT) according to one embodiment of the present invention;

FIG. 9 illustrates conversion properties of an offset circuit according to one embodiment of the present invention;

FIG. 10 is a flow chart showing the final scanning action of the device according to one embodiment of the present invention;

FIG. 11 is a flow chart showing the pre-scanning action of the device according to one embodiment of the present invention;

FIG. 12 is a flow chart showing the pre-scanning action of the device according to one embodiment of the present invention;

FIG. 13 is a flow chart showing the final scanning action of the device according to one embodiment of the present invention;

FIG. 14 is a flow chart showing the final scanning action of the device according to one embodiment of the present invention;

FIG. 15 illustrates the relationship between the pre-scan and the aspect ratio of the image reading device; and

FIG. 16 is a flow chart showing the pre-scanning action of the image reading device of the prior art.

### DETAILED DESCRIPTION OF PREFERRED EMBODIMENTS

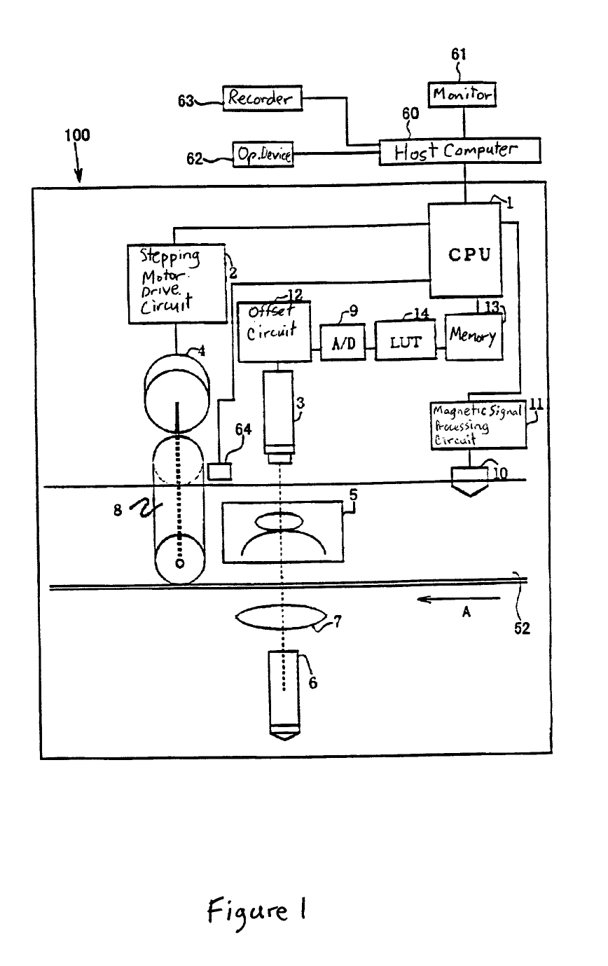

FIG. 1 is a block figure showing an image reading system of an embodiment of the present invention. The present invention will be explained with reference to FIG. 1.

A scanner 100 is connected to a host computer 60. Furthermore, a monitor 61, an operation device 62 and a recording device 63 are connected to the host computer 60. The monitor 61 is a device, for example, a CRT, for displaying a command that arrives from the host computer 60. The operation device 62 comprises an input device such as a keyboard and/or a mouse. The recording device 63 is a hard disc drive or so forth for recording. Other alternatives to a hard disc drive can serve as the recording device 63, for example, a floppy disc drive or a magneto optical disc drive. A floppy disc drive or a magneto optical disc drive record the data to a memory medium such as a floppy disc or a magneto optical disc.

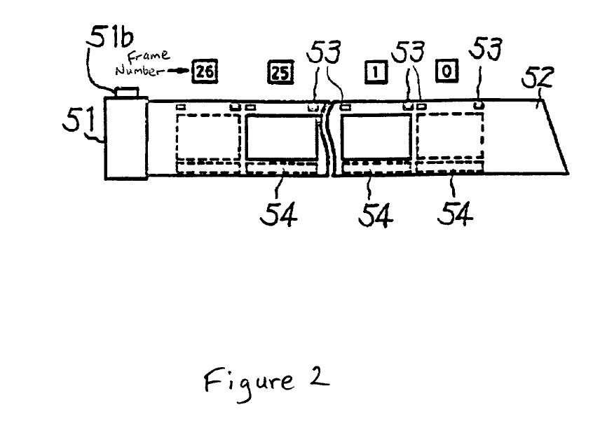

A film 52 having a magnetic storage area 54 will be explained with reference to FIG. 2. The film 52 is made so as to allow one end to be fixed in place to a spool 51b, and the remainder of the film is received inside a film cartridge 51. Each photographic frame is provided with perforations 53 and a magnetic storage area 54.

Next, an explanation of the scanner 100 will be provided using FIG. 1. A CPU 1 controls each device inside the scanner 100 by receiving commands from the host computer 60. A light source 6 is a device for illuminating the film 52. The light source 6 is driven by an illumination drive circuit (not shown), and light illuminates in the order of red, green, and blue. Light that is generated from the light source 6 passes through the film original 5 and forms an image at a linear image sensor 3 by way of a projection optical system 7. The linear image sensor 3 transfers the light of the formed image by the projection optical system, otherwise referred to as light that corresponds to the image of the film original, to the electrical image signal. The linear sensor 3 is, for example, a monochromatic line sensor, and performs primary scanning in the longitudinal direction.

A stepping motor drive circuit 2 drives a stepping motor 4 based upon the commands of the CPU 1. A roller 8 rolls due to the transference of a driving force of the stepping motor 4 to the roller 8. Film 52 is moved by the revolution of the roller 8. The movement direction A of the film 52 is perpendicular to the primary scanning direction of the linear image sensor 3, and will be referred to hereafter as the auxiliary scanning direction. Moreover, in the present embodiment, auxiliary scanning is performed by way of the movement of the film 52, but auxiliary-scanning may also be performed by way of the movement of the linear image sensor 3.

The offset circuit 12 is a circuit that adjusts the direct current level of the image signal that is output from the linear image sensor 3. An A/D converter 9 converts the analog image signal to digital image data. A Look Up Table (LUT) 14 is a table for converting the gradation properties of the digital image data. A memory 13 temporarily keeps the digital image data that is gradation converted by the LUT 14. The digital image data that is kept in the memory 13 is output to the host computer 60 through the CPU 1.

A magnetic head 10 reads the data that is stored in the magnetic storage area 54 of the film 52, as well as writes the data to the magnetic storage area 54. A magnetic signal processing circuit 11 is controlled by the CPU 1, and drives the magnetic head 10.

A photo-interrupter 64 (FIG. 1) detects perforations 53 (of the film 52). The photo-interrupter 64 is equipped with a light emitting component and a light receiving component, and detects the perforations 53 by the existence or non-existence of a reflection from the film 52.

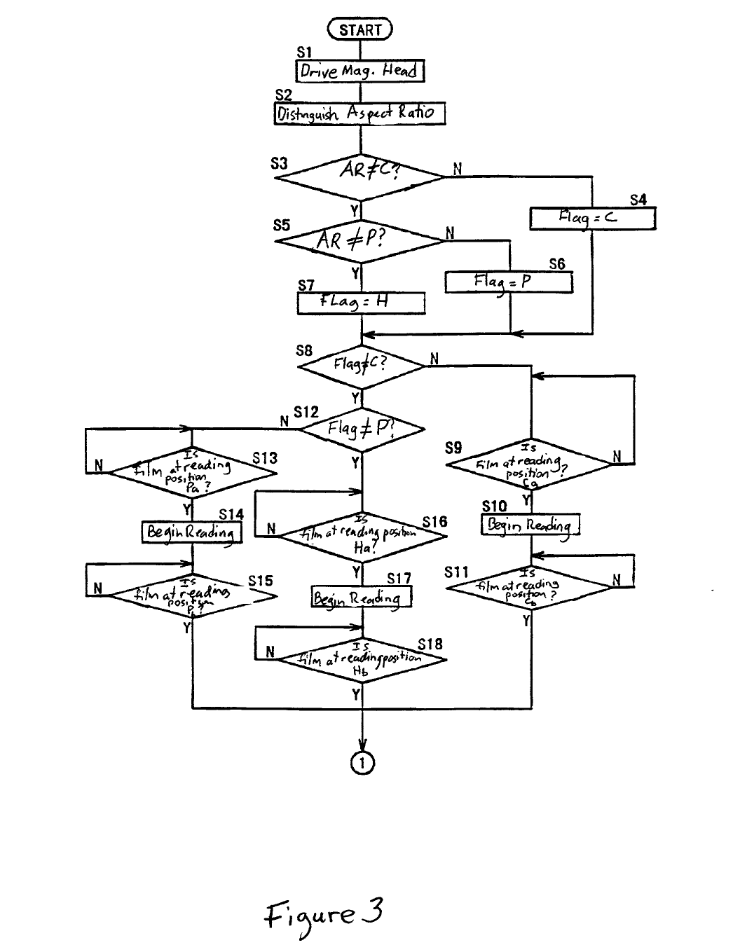

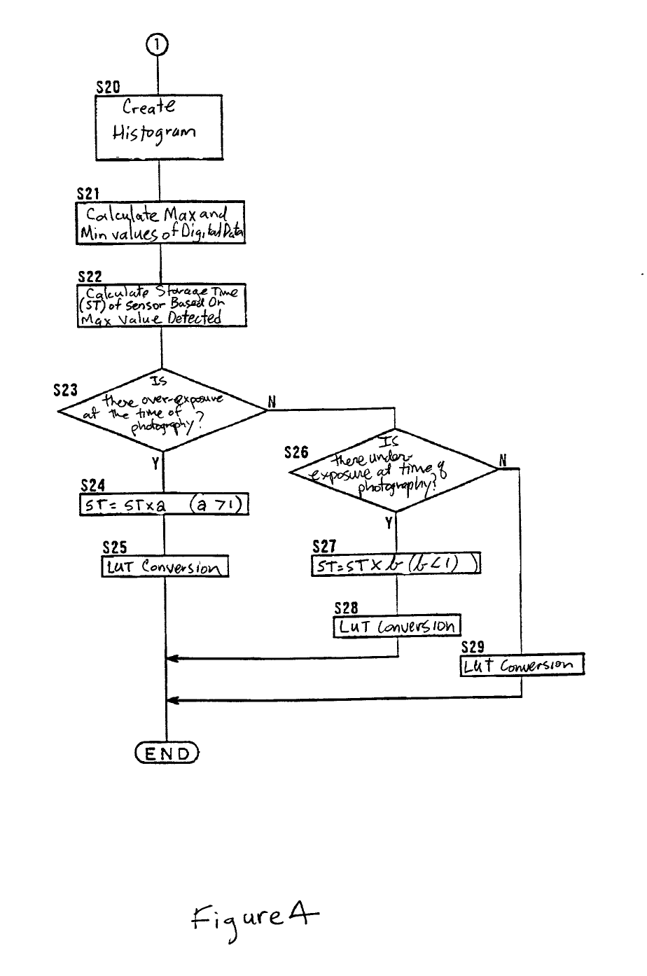

Next, an explanation will be given of a process according to the first embodiment of the present invention. An explanation of the control performed by way of the CPU 1 for the pre-scan will be provided using the flow charts of FIGS. 3 and 4. The flow chart of FIG. 3 begins when the perforation detection signal is received from the photo interrupter 64 subsequent to receiving the pre-scan command from the host computer 60. At this time, the film 52 moves in the direction of the arrow A (FIG. 1) to the auxiliary scanning direction. Hereafter, an explanation for the reading of the negative film will be given, but the invention is not limited to such.

In S1, the magnetic signal processing circuit 11 is driven. The magnetic signal processing circuit 11 drives the magnetic head 10 and reads the magnetic data of the magnetic storage area 54. Both the aspect ratio data, which comprises the data of the image size at the time of photography, as well as the exposure data at the time of photography, are included in the magnetic data.

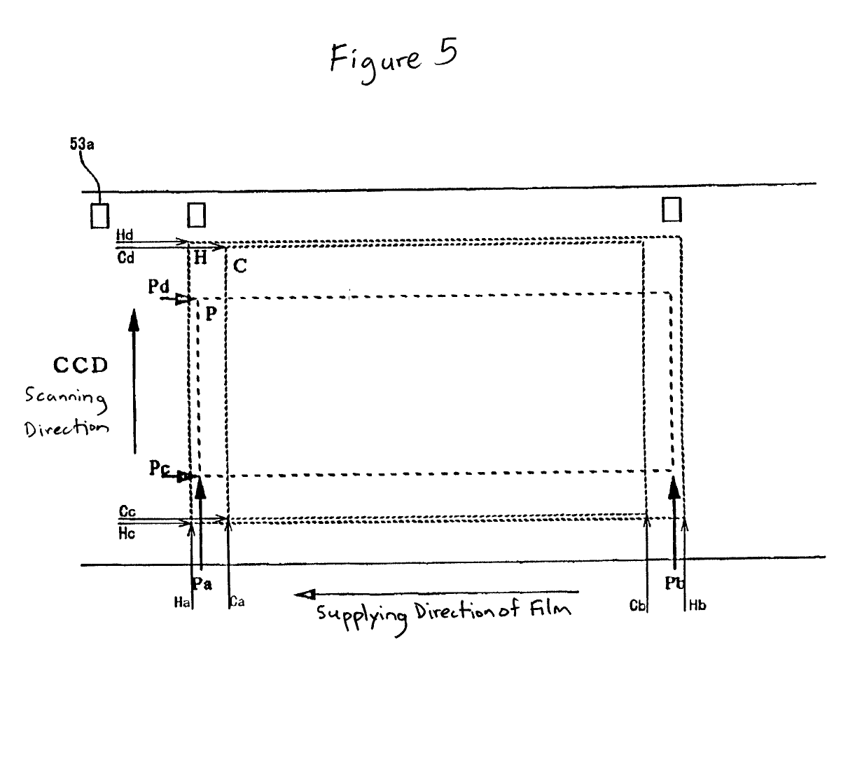

The aspect ratio data is data which indicates which aspect ratio is used at the time of photography. There are 3 types of aspect ratios as shown in FIG. 5: there is the C size which has a vertical and horizontal ratio of 2:3, the H size which has a vertical and horizontal ratio of 9:16, and the P size which has a vertical and horizontal ratio of 1:3.

The exposure data is the data that indicates, at the time of photography, whether there is an appropriate exposure, or if there is over-exposure, or if there is under-exposure.

Next, in S2, it is recognized from the data that is read whether the aspect ratio at the time of photography is C, H, or P. Next, proceed to S3 to determine if the recognized aspect ratio is not C (AR≠C). If the answer is Yes, proceed to S5. If the answer is No, it is determined that the aspect ratio is C, and at S4, the flag C is set, and the program proceeds to S8.

At S5 it is determined whether the aspect ratio is not P (AR≠P). At S5, if the answer is Yes, then it is determined that the aspect ratio is H, and the program proceeds to S7 and flag H is given. If at S5 the answer is No, then it is determined that the aspect ratio is P and the flag P is set at S6, and the program proceeds to S8.

Next, at S8, it is determined if the flag C is not set. If the answer at S8 is Yes, then proceed to S12. If the answer at S8 is No, then proceed to S9. At S9, it is determined if the position Ca (FIG. 5) of the auxiliary scanning direction of the film 52 has arrived at the reading position of the linear image sensor, and it waits until Yes it determined. The specific determination is performed by determining whether the stepping motor drive circuit 2 has produced a predetermined number of pulses or not to the stepping motor 4 after completing the detection of the perforations 53 that are on the rear side of the previous frame.

When Yes is determined at S9, the command to begin reading is issued to the linear image sensor 3 at S10. The linear image sensor 3 executes the image reading at a predetermined time of storage for every one line.

The linear image sensor 3 outputs, to the offset circuit 12, the image signal for the one line portion that was read. The offset circuit 12 then adds a direct current offset to that one line portion of the image signal, and outputs it to the A/D converter 9. The A/D converter 9 then converts the image signal to digital image data, and outputs it to the LUT 14. The LUT 14, after converting the digital image data by a table of gradation properties, writes it to the memory 13. The LUT 14 prohibits, from within the one line of digital image data, the writing of portions that are unrelated to the image that is within Cc to Cd of the primary scanning direction as shown in FIG. 5. In other words, the LUT 14 writes to the memory 13 only that digital image data that relates to the image that is between Cc and Cd of the primary scanning direction.

Furthermore, at S11, a determination is made as to whether the position Cb of the auxiliary scanning direction of the film 52 has arrived at the reading position of the linear image sensor 3, and it continues reading the image until Yes is determined. When Yes is determined at S11, the program proceeds to S20 (FIG. 4).

At S12, it is determined if the flag P is not set. If the answer is Yes at S12, then the program proceeds to S16. If the answer is No at S12, then the program proceeds to S13. At S13, a determination is made as to whether the position Pa of the auxiliary scanning direction of the film 52 has arrived to the reading position of the linear image sensor 3, and it waits until Yes can be determined. The specific determination is performed by determining whether the stepping motor drive circuit 2 has produced a predetermined number of pulses or not to the stepping motor 4 after completing the detection of the perforations 53 that are on the rear side of the previous frame.

When Yes is determined at S13, the command to begin reading is issued to the linear image sensor 3 at S14. The linear image sensor 3 executes the image reading at a predetermined time of storage for every one line.

The linear image sensor 3 outputs, to the offset circuit 12, the image signal for the one line portion that was read. The offset circuit 12 then adds a direct current offset to that one line portion of the image signal, and outputs it to the A/D converter 9. The A/D converter 9 then converts the image signal to image data, and outputs it to the LUT 14. The LUT 14, after converting the digital image data by a table of gradation properties, writes to the memory 13. The LUT 14 prohibits, from within the one line of digital image data, the writing of portions that are unrelated to the image that is within Pc to Pd of the primary scanning direction as shown in FIG. 5. In other words, the LUT 14 writes to the memory 13 only that digital image data that relates to the image that is between Pc and Pd of the primary scanning direction.

Furthermore, at S15, a determination is made as to whether the position Pb of the auxiliary scanning direction of the film 52 has arrived at the reading position of the linear image sensor 3, and it continues reading the image until Yes is determined. When Yes is determined at S15, the program proceeds to S20.

At S16, a determination is made as to whether the position Ha of the auxiliary scanning direction of the film 52 has arrived to the reading position of the linear image sensor 3, and it waits until Yes can be determined. The specific determination is performed by determining whether the stepping motor drive circuit 2 has produced a predetermined number of pulses to the stepping motor 4 after completing the detection of the perforations 53 that are on the rear side of the previous frame.

When Yes is determined at S16, the command to begin reading is issued to the linear image sensor 3 at S17. The linear image sensor 3 executes the image reading at a predetermined time of storage for every one line.

The linear image sensor 3 outputs, to the offset circuit 12, the image signal for the one line portion that was read. The offset circuit 12 then adds a direct current offset to the one line portion of image signal, and outputs it to the A/D converter 9. The A/D converter 9 then converts the image signal to a digital image data, and outputs it to the LUT 14. The LUT 14, after converting the digital image data by a table of gradation properties, writes it to the memory 13. The LUT 14 prohibits, from within the one line of digital image data, the writing of portions that are unrelated to the image that is within Hc to Hd of the primary scanning direction as shown by FIG. 5. In other words, the LUT 14 writes to the memory 13 only the digital image data that relates to the image that is between Hc and Hd of the primary scanning direction.

Furthermore, at S18, a determination is made as to whether the position Hb of the auxiliary scanning direction of the film has arrived at the reading position of the linear image sensor 3, and it continues reading the image until Yes is determined. When Yes is determined at S18, the program proceeds to S20.

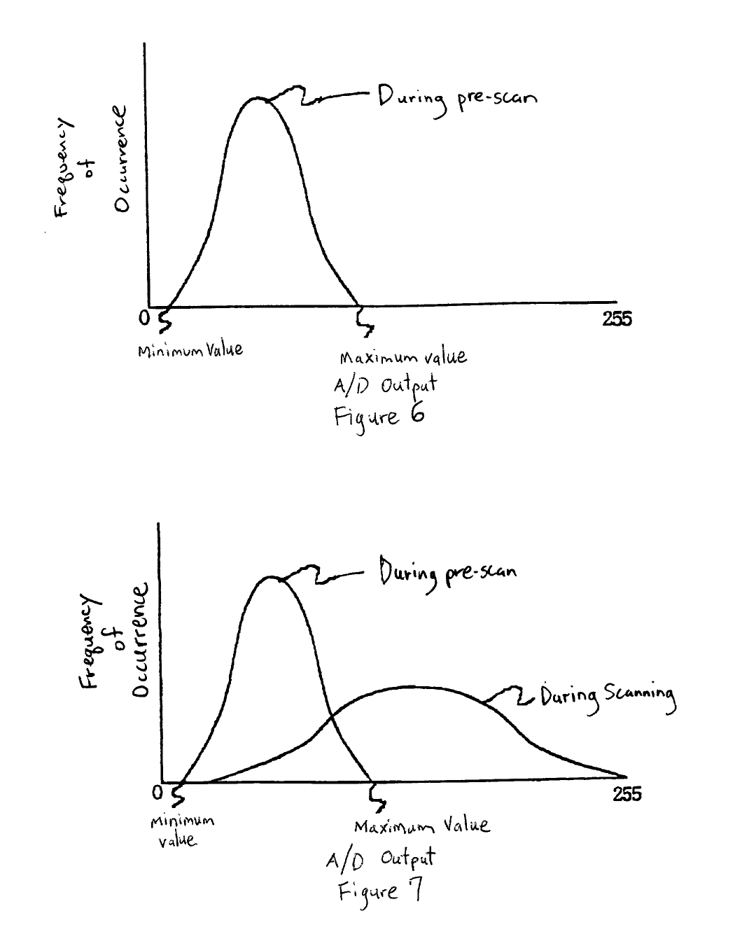

At S20, a histogram such as that shown in FIG. 6 can be made based upon the digital image data that is read.

The horizontal axis of the histogram in FIG. 6 is the output level of the A/D converter, in other words, it is the level of the digital image data. The brightest portion of the original 5 corresponds to the maximum value of the digital image data level, and the darkest portion corresponds to the minimum value of the digital image data level. The A/D converter 9 of the present embodiment can express values for digital image data levels from 0 to 255 because it functions at an 8 bit conversion. The vertical axis of FIG. 6 is the rate of generation for the digital image data level. The greater the value indicates the greater number of data of that digital image data level.

Next, the detection of the maximum value and the minimal value for the digital image data level is performed at S21.

Next, at S22, the storage time of one reading line of the linear image sensor 3 at the time of the primary scan is calculated based upon the maximum value that was detected at S21. Specifically, as is shown in FIG. 7, storage time is calculated so that the maximum value of the level for the digital image data becomes the full scale of the A/D converter 9 output range. The result of the calculation is recorded in the memory of the CPU 1. The calculation formula for the storage time is as shown below.

Storage time (ST)=storage time at the time of pre-scan×255/maximum value of the digital image data level.

Next, at S23, a determination is made whether the exposure data that was read at S1 (FIG. 3) is data indicating over-exposure. If the answer as S23 is No, then the program proceeds to S26. If the answer at S23 is Yes, then the program proceeds to S24, and multiplies the storage time calculated at S22 times a predetermined value a. The value a is a value greater than 1. The present embodiment explains the reading for a negative film. The film original 5 has higher optical density, in other words, it becomes a darker original when there is over exposure. Accordingly, accommodations are made to make the storage time longer. In the case that the film original is a positive film, accommodations may be taken to make the storage time shorter. The result of the calculation is stored in the memory of the CPU 1.

Next, at S25, the gradation table of the LUT 14 is converted. An explanation of the specific calculations will be provided hereafter.

First, the minimum value that represents the image data for when the image was read at the storage time that was calculated at S24, is calculated as the minimum value 2. The calculation formula is as follows.

Minimum value 2=minimum value×(255/the maximum value of the digital image data level)×a

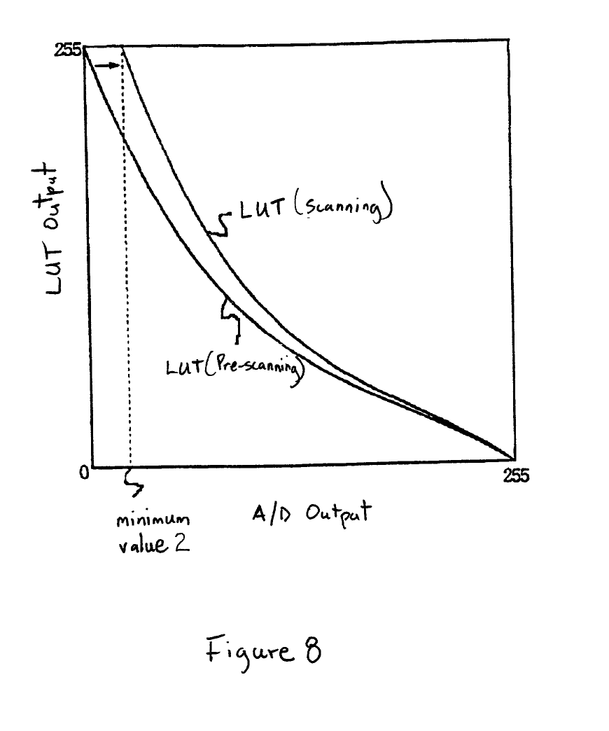

Furthermore, the LUT gradation table for the time of the final scan is set from the LUT gradation table for the time of the pre-scan, based upon the minimum value 2 that is calculated. Specifically, as is shown in FIG. 8, the minimum value 2 is entered so as to be set at 255 (the maximum output value of the LUT). The result of this setting is stored in the memory of the CPU 1.

With the LUT gradation table at the time of the pre-scan, when the input value of the LUT 14 is 0, the output is set to produce 255 (the maximum output value). However, it is impossible to input a value between 0 and the minimum value 2 into the LUT 14. Due to the setting of S25, when the input value is the minimum value 2, the LUT 14 is set to output 255 (the maximum output value of the LUT). It is possible to produce an output with lower gradation jumps because the LUT 14 performs gradation conversion by a gradation table that excludes the unnecessary values of 0 to the minimum value 2.

When the process at S25 is completed, the program proceeds to the End, and the process of this flow chart is over.

At S26, it is determined if the exposure data read at S1 indicates under-exposure. If the answer as S26 is No, then the program proceeds to S29. If the answer at S26 is Yes, then the program proceeds to S27, and multiplies a predetermined value b times the storage time that was calculated at S22. The value b is a value smaller than 1. The present embodiment is explaining the reading for a negative film. The film original 5 has lower optical density, in other words, it becomes a brighter original when there is under exposure. Accordingly, accommodations are made to make the storage time shorter. In the case that the film original is a positive film, accommodations may be taken to make the storage time longer. The result of the calculation is stored in the memory of the CPU 1.

Next, at S28, the gradation table of the LUT 14 is converted. An explanation of the specific calculations will be provided hereafter.

First, the minimum value that represents the digital image data for when the image was read at the storage time that was calculated at S27, is calculated as the minimum value 2. The calculation formula is as follows.

Minimum value 2=minimum value×(255/the maximum value of the digital image data level)×b, where b is a value less than 1.

Furthermore, the LUT gradation table for the time of the final scan is set from the LUT gradation table for the time of the pre-scan, based upon the minimum value 2 that is calculated. Specifically, as is shown in FIG. 8, the minimum value 2 is entered so as to be set at 255 (the maximum output value of the LUT). It is possible to produce an output with lower gradation jumps because the LUT 14 performs gradation conversion by a gradation table that excludes the unnecessary values of 0 to the minimum value 2. The results of the setting are stored in the memory of the CPU 1.

When the process at S28 is completed, the program proceeds to the End, and the process of this flow chart is over.

At S29, the gradation table of the LUT 14 is converted. An explanation of the specific calculations will be provided hereafter.

First, the minimum value that represents the digital image data for when the image was read at the storage time that was calculated at S22, is calculated as the minimum value 2. The calculation formula is as follows.

Minimum value 2=minimum value×255/the maximum value of the digital image data level.

Furthermore, the LUT gradation table for the time of the final scan is set from the LUT gradation table for the time of the auxiliary scan, based upon the minimum value 2 that is calculated. Specifically, as is shown in FIG. 8, the minimum value 2 is entered so as to be set at 255 (the maximum output value of the LUT). It is possible to produce an output with lower gradation jumps because the LUT 14 performs gradation conversion by a gradation table that excludes the unnecessary values of 0 to the minimum value 2. The results of the setting are stored in the memory of the CPU 1.

When the process at S29 is completed, the program proceeds to the End, and the process of this flow chart is over.

In addition, as described above, the maximum value of the digital image data level is arranged so as to be the full scale of the output range of the A/D converter 9 by changing the storage time of the linear image sensor 3. On the other hand, the maximum value of the digital image data level can also be arranged to be the full scale of the output range of the A/D converter 9 by changing the offset level of the offset circuit 12 as shown in FIG. 9. In addition to the setting for the minimum value, the process is simply performed as the process described above from S23 to S29.

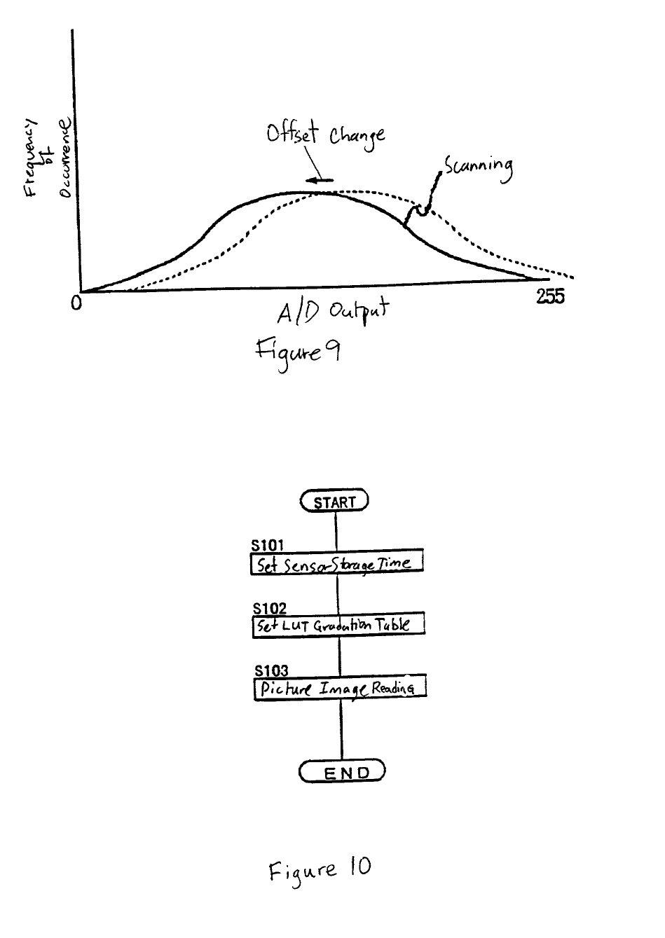

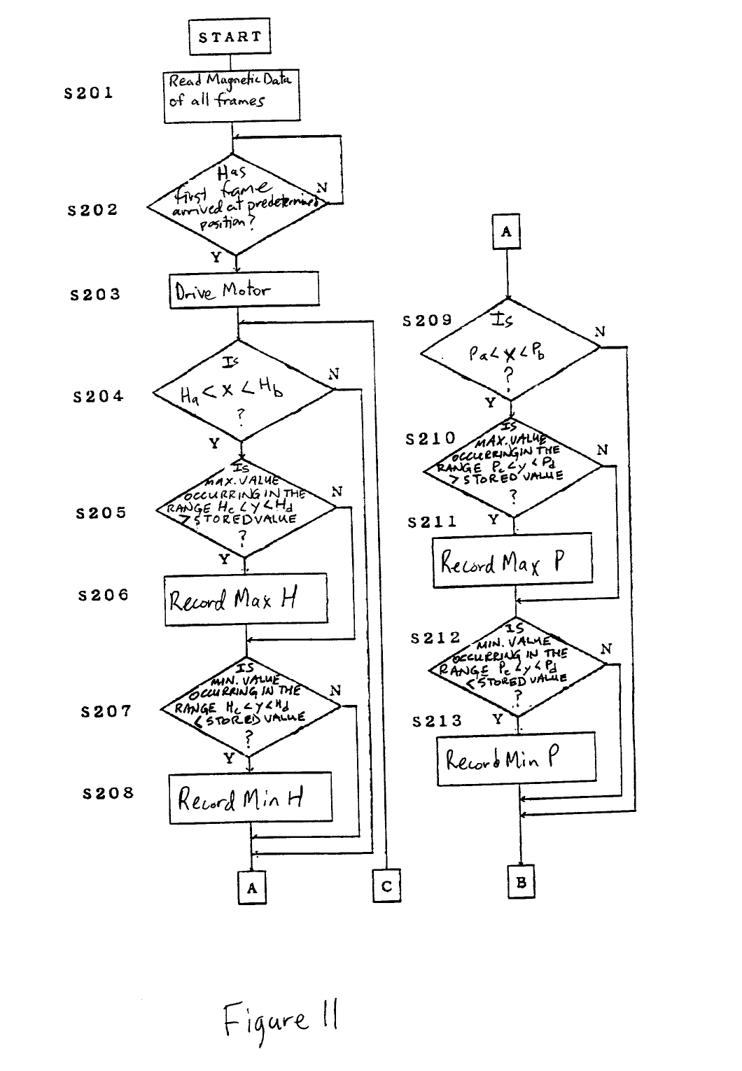

Next, the controlling of the final scanning that is performed by way of the CPU 1 will be explained using the flow chart of FIG. 10.

In response to the user operating the operation device 62, the host computer 60 produces a final scanning command to the scanner 100. The present flow chart begins with the reception of the final scanning command.

At S101, the storage time for the sensor for the final scan is set. The sensor storage time that is ultimately calculated by S22, S24, and S27 of the flow chart of FIG. 4, is selected.

Next, at S102, the gradation conversion table of the LUT 14 for the final scan is set. The gradation conversion table that is ultimately set by S25, S28, and S29 is selected.

Next, at S103, the image reading is performed based upon the settings which occurred at S101 and S102. When the image reading is completed, the process ends by proceeding to END.

In the above embodiment, the exposure amount of the linear image sensor 3 was set according to the setting of the storage time that took place for 1 line of the linear image sensor 3. However, the exposure amount may also be set by arranging the stop between the linear image sensor 3 and the film.

In the above embodiment, the storage time of the linear image sensor 3 is calculated based upon the maximum value of the image data that occurs in the pre-scan. On the other hand, one may also use any element of the image such the average value of the image data which occurred in the pre-scan, or the combination of the maximum value, minimum value, and average value of the image data.

In addition, when there are multiple types of photographic data, the reading conditions may also be obtained by running pre-scan one time based on those types of photographic data. For example, the H, C, and P aspect ratios of the present embodiment are three types of photographic data. However, with one pre-scan, the maximum and minimum levels for each of the H, C, and P can be derived, and the reading conditions can be set based on each of these. After completion, one can be selected from these. Furthermore, a detailed account of this method will be given in a second embodiment according to the present invention.

Additionally, in the above embodiment, the image size at the time of photography is arranged so as to determine which of H, C or P is selected. However, the present embodiment is not restricted to this if this is data on whether to trim a portion of the film image.

Furthermore, if the setting of the image reading is based on the magnetic data of the film, first the magnetic data is stored in the storage medium of the recording device 63, and then the rest may be performed based on the data that was read from that point. If it is first stored to the storage medium, then it is not necessary to drive the film at the time that the magnetic head 10 is reading the magnetic data when subsequently reading the image, and thus appropriate image reading is made easy.

Next, the second embodiment of the present invention will be explained with reference to FIGS. 5-14.

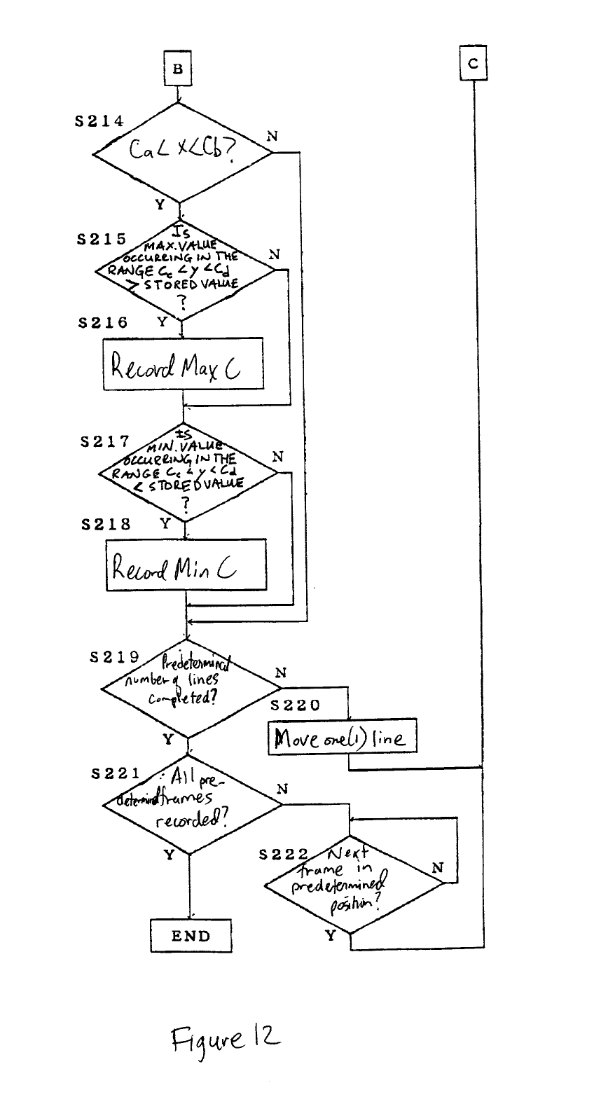

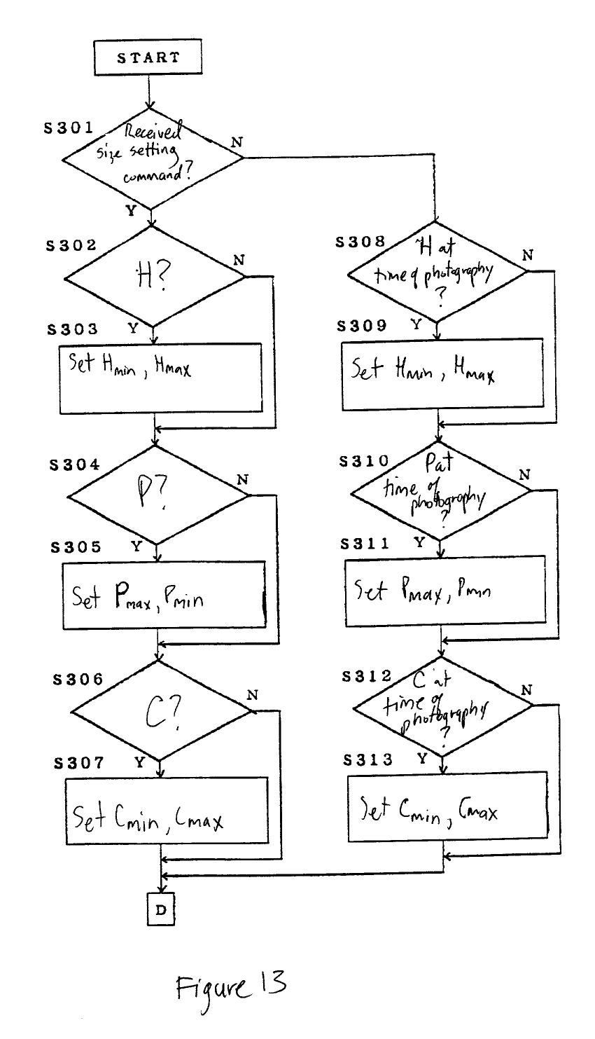

An explanation of the controlling of the pre-scan by the CPU 1 is provided hereafter with reference to FIGS. 11 and 12.

The flow chart of FIG. 11 begins with the reception of a pre-scanning command from the host computer 60. The following is an explanation regarding the reading of negative film, but the invention is not limited to reading negative film.

At step S201, the magnetic data of the magnetic storage area 54 for each frame, from the 0th frame to the last frame, is read. First, the stepping motor drive circuit 2 begins to drive the stepping motor 4. The roller 8 begins to move the film 52 in the reverse direction of the arrow A due to the driving force of the stepping motor 4. Next, the magnetic signal processing circuit 11 is driven to drive the magnetic head 10, which reads the magnetic data of each frame of the magnetic storage area 54. The aspect ratio data which is the data of the image size at the time of photography, as well as the exposure data at the time of photography, are both included in the magnetic data. In addition, the data for the total number of frames of film is included in the magnetic data of the 0th frame. The magnetic data of each frame is recorded to the storage area that corresponds to each frame. When the reading of the magnetic data for each frame is completed, the stepping motor drive circuit 2 is driven, and the stepping motor 4 is rotated in the reverse direction. In other words, the film 52 is moved in the direction of arrow A by way of the driving force of the stepping motor 4.

At S202, a determination is made as to whether the first frame has arrived at the predetermined position. Specifically, it determines whether the perforation detection signal has been received from the photo interrupter 64. In the case that it is determined that the first frame has not arrived at the predetermined position, it waits at S202. Furthermore, the program proceeds to S203 when it is determined that the first frame has arrived at the predetermined position.

At S203, the stepping motor drive circuit 2 is driven, and furthermore, the stepping motor 4 is driven only a predetermined amount that allows Ha of the original 5 to arrive at the reading position of the linear image sensor 3. When the stepping motor 4 is driven the predetermined amount at S203, the program proceeds to S204.

At S204, a determination is made as to whether the reading position of the linear image sensor 3 which is in the auxiliary scan direction is within the parameters of Ha and Hb of the original 5. If Yes is determined at S204, the program proceeds to S205. If No is determined at S204, then the program proceeds to S209.

At S205, the linear image sensor 3 photo-electrically converts the light from the line that corresponds to the reading position of the linear sensor 3 of the original 5. In addition, the maximum value among the plural outputs from each pixel of the linear image sensor 3 is detected. The pixels of the linear image sensor 3 correspond to the area y which is between Hc and Hd on the axis of the primary scanning direction. Furthermore, a determination is made as to whether the maximum value is greater than the storage value of the maximum value storage area for the size H of the memory 13. If Yes is determined at S205, then the program proceeds to S206; and if No is determined, then the program proceeds to S207.

At S206, the maximum value that was detected at S205 is recorded to the H size maximum value storage area of memory 13.

At S207, the minimum value among the plural outputs from each pixel of the linear image sensor 3 is detected. The pixels of the linear image sensor 3 correspond to the area y which is between Hc and Hd on the axis of primary scanning direction. Furthermore, a determination is made as to whether the minimum value is smaller than the storage value of the minimum value storage area for the size H of the memory 13. If Yes is determined at S207, then the program proceeds to S208; and if No is determined, then the program proceeds to S209.

At S208, the minimum value that was detected at S207 is recorded to the H size minimum value storage area of memory 13.

At S209, a determination is made as to whether the reading position of the linear image sensor 3 which is in the auxiliary scan direction is within the parameters of Pa and Pb of the original 5. If Yes is determined at S209, the program proceeds to S210. If No is determined at S209, then the program proceeds to S214.

At S210, the linear image sensor 3 photo-electrically converts the light from the line that corresponds to the reading position of the linear sensor 3 of the original 5. In addition, the maximum value among the plural outputs from each pixel of the linear image sensor 3 is detected. The pixels of the linear image sensor 3 correspond to the area y which is between Pc and Pd on the axis of primary scanning direction. Furthermore, a determination is made as to whether the maximum value is greater than the storage value of the maximum value storage area for the size P of the memory 13. If Yes is determined at S210, then the program proceeds to S211; and if No is determined, then the program proceeds to S212.

At S211, the maximum value that was detected at S210 is recorded to the P size maximum value storage area of memory 13.

At S212, the minimum value among the plural outputs from each pixel of the linear image sensor 3 is detected. The pixels of the linear image sensor 3 correspond to the area y which is between Pc and Pd on the axis of primary scanning direction. Furthermore, a determination is made as to whether the minimum value is smaller than the storage value of the minimum value storage area for the size P of the memory 13. If Yes is determined at S212, then the program proceeds to S213; and if No is determined, then the program proceeds to S214.

At S213, the minimum value that was detected at S212 is recorded to the P size minimum value storage area of memory 13.

At S214, a determination is made as to whether the reading position X of the linear image sensor 3 which is in the auxiliary-scan direction is within the parameters of Ca and Cb of the original 5 or not. If Yes is determined at S214, the program proceeds to S215. If No is determined at S214, then the program proceeds to S219.

At S215, the linear image sensor 3 photoelectrically converts the light from the line that corresponds to the reading position of the linear sensor 3 of the original 5. In addition, the maximum value among the plural outputs from each pixel of the linear image sensor 3 is detected. The pixels of the linear image sensor 3 correspond to the area y which is between Cc and Cd on the axis of primary scanning direction. Furthermore, a determination is made as to whether the maximum value is greater than the storage value of the maximum value storage area for the size C of the memory 13. If Yes is determined at S215, then the program proceeds to S216; and if No is determined, then the program proceeds to S217.

At S216, the maximum value that was detected at S215 is recorded to the C size maximum value storage area of memory 13.

At S217, the minimum value among the plural outputs from each pixel of the linear image sensor 3 is detected. The pixels of the linear image sensor 3 correspond to the area y which is between Cc and Cd on the axis of primary scanning direction. Furthermore, a determination is made as to whether the minimum value is smaller than the storage value of the minimum value storage area for the size C of the memory 13. If Yes is determined at S217, then the program proceeds to S218; and if No is determined, then the program proceeds to S219.

At S218, the minimum value that was detected at S217 is recorded to the C size minimum value storage area of memory 13.

At S219, a determination is made as to whether a one frame portion, in other words, the read image of an entire line from Ha to Hb, is completed. The number of lines that will be read from Ha to Hb is set in advance to the CPU 1. Furthermore, it determines whether a one frame portion of image reading is completed by determining whether the image reading of a predetermined number of lines is completed. If Yes is determined at S219, then the program proceeds to S221. If No is determined at S219, then the program proceeds to S220.

At S220, the stepping motor drive circuit 2 is driven, and the stepping motor 4 is driven so as to move the film 52 in the direction of the arrow A a distance for reading one line. Then, it returns to S204 and repeats the above process.

At S221, it determines whether the record of a predetermined number of frames has been completed. The predetermined number of frames is the frame count that is based upon the data of the total number of frames that was obtained at S201.

Moreover, a predetermined number of frames is used in the present embodiment, however, the user may also set a selected number of frames, and that number of frames that is selected by the user may also be determined as the predetermined number of frames for S221.

If yes is determined at S221, then the process of the present flow chart is completed. However, if No is determined at S221, then the program proceeds to S222. At S222, a determination is made as to whether the frame to be read next has arrived at the predetermined position. If No is determined at S222, then it waits; and if Yes is determined, then it returns to S204 and repeats the aforementioned process.

With the above process, the detection of the maximum value and the minimum value for the image data that relates to all the H, C, and P sizes can be realized. Moreover, in the above embodiment, the maximum value and the minimum value of the image data are stored in the memory 13. On the other hand, it may also be stored in the memory of the host computer 60.

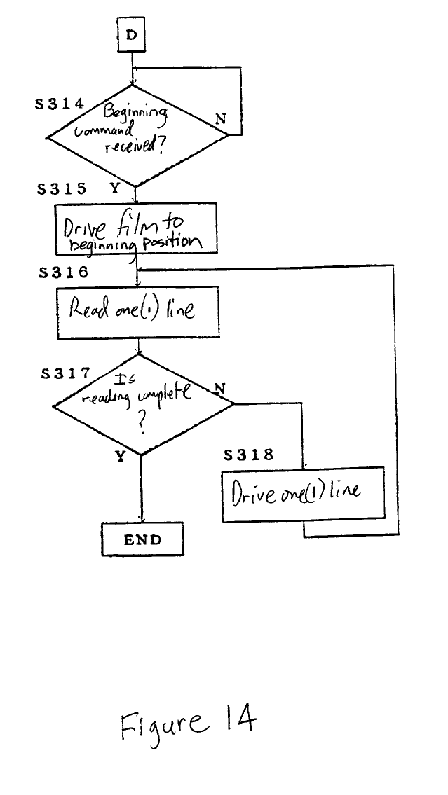

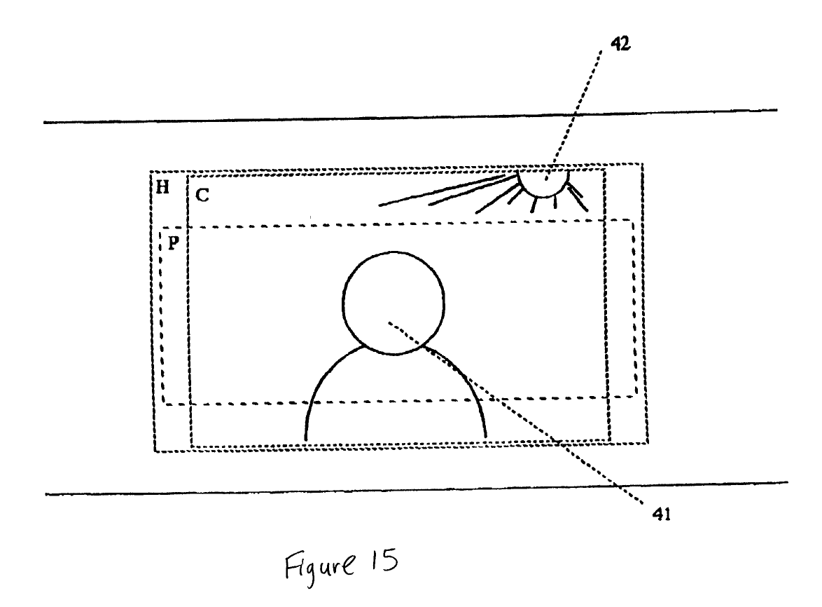

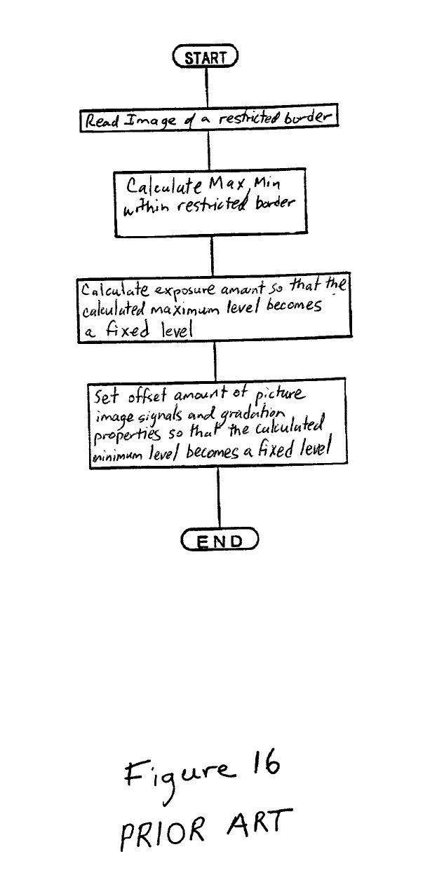

Next, an explanation of the controlling that occurs with the final scanning by way of the CPU 1 will be provided using the flow charts of FIGS. 13 and 14.

The monitor 61, based on the commands of the host computer 60, displays the final scanning menu. Within the final scanning menu, the thumb-nail images corresponding to the images of each frame that were read by the pre-scan are displayed. The user operates the operation device 62 while viewing the menu of the monitor 61, and can select the image for final scanning. In addition, the user, by operating the operation device 62 while viewing the menu of the monitor 61, has the ability to set the image reading to any of the sizes H, C, or P, or the user may set the image reading size that was included in the magnetic data.

The present flow chart begins when the setting of the above menu is complete and the setting-completion signal is entered to the scanner from the host computer 60.

At S301, a determination is made as to whether the size setting command has been received. In other words, a determination is made as to whether the user has set the image reading size for any of the H, C, or P sizes. If Yes is determined at S301 then the program proceeds to S302; and if No is determined, then the program proceeds to S308.

At S302, a determination is made as to whether the size that is selected is the size H. If Yes is determined at S302 then the program proceeds to S303; and if No is determined, then the program proceeds to S304.

At S303, the reading conditions are set based upon the maximum value that is stored in the H size Maximum value storage area, and the minimum value that is stored in the H size minimum value storage area. The reading conditions are those conditions in the LUT 14 gradation table and the storage time for reading 1 line of the linear image sensor 3. Moreover, these settings perform the same process as S22 and S29 of FIG. 4 of the first embodiment.

At S304, a determination is made as to whether the size that is selected is the size P. If Yes is determined at S304 then the program proceeds to S305; and if No is determined, then the program proceeds to S306.

At S305, the reading conditions are set based upon the maximum value that is stored in the P size Maximum value storage area, and the minimum value that is stored in the P size minimum value storage area. The reading conditions are those conditions in the LUT 14 gradation table and the storage time for reading 1 line of the linear image sensor 3. Moreover, these settings perform the same process as S22 and S29 of FIG. 4 of the first embodiment.

At S306, a determination is made as to whether the size that is selected is the size C. If Yes is determined at S306 then the program proceeds to S307; and if No is determined, then the program proceeds to S314.

At S307, the reading conditions are set based upon the maximum value that is stored in the C size Maximum value storage area, and the minimum value that is stored in the C size minimum value storage area. The reading conditions are those conditions in the LUT 14 gradation table and the storage time for reading 1 line of the linear image sensor 3. Moreover, these settings perform the same process as S22 and S29 of FIG. 4 of the first embodiment.

At S308, a determination is made as to whether the size at the time of photography is the size H. Specifically, it determines whether the data for size H is stored in the storage area of memory 13 according to the frame to be final scanned. If Yes is determined at S308, then the program proceeds to S309, it performs the same process as S303. If No is determined at S308, then the program proceeds to S310.

At S310, a determination is made as to whether the size at the time of photography is the size P. Specifically, it determines whether the data for size P is stored in the storage area of memory 13 according to the frame to be final scanned. If Yes is determined at S310, then the program proceeds to S311, it performs the same process as S305. If No is determined at S310, then the program proceeds to S312.

At S312, a determination is made as to whether the size at the time of photography is the size C. Specifically, it determines whether the data for size C is stored in the storage area of memory 13 according to the frame to be final scanned. If Yes is determined at S312, then the program proceeds to S313, it performs the same process as S307. If No is determined at S312, then the program proceeds to S314.

At S314, a determination is made as to whether the scanner 100 has received the image reading beginning command from the host computer 60. The image reading beginning command is sent from the host computer 60 to the scanner 100 in response to the user operating the operation device 62 following the menu.

Next, at S315, the stepping motor drive circuit 2 is driven and the film 52 is moved by way of the stepping motor 4. In addition, the frame numbers of the film 52 are detected by counting the perforation detection signals from the photo-interrupter 64.

Next, at S316, one line of image data is read. Specifically, the light source 6 is driven and the red, green and blue lights are illuminated in order. The linear image sensor 3 photo-electrically converts in turn the light that is formed by the projection optical system 7. In other words, the light that corresponds to the image of the original 5 and outputs them each as a red image signal, a green image signal, and a blue image signal.

Next, at S317, a determination is made as to whether the area of the image reading is completely read. Specifically, a determination is made as to whether the reading of the line count according to the selected H, C, or P image sizes is completed. If Yes is determined at S317 then the process of the present flow chart is completed. If No is determined at S317, then the program proceeds to S318.

At S318, the stepping motor drive circuit 2 is driven, the film 52 is moved by the stepping motor 4 a distance for reading one line. Then, it returns to S316 and repeats the aforementioned process.

As described above in the second embodiment, the maximum value and the minimum value for all the H, C, and P sizes can be recorded for 1 frame by performing only one pre-scan; and the image reading conditions is set based upon the maximum value and the minimum value. After setting one reading size for image reading conditions, it is not necessary to re-scan even if setting to a different size of image reading conditions. Furthermore, even if the user changes to multiple sizes of image reading conditions, it can be set in a short time.

With the device described, a high quality image that matches the conditions at the time of photography can be read due to the setting of reading conditions of an image reading device that is based upon a photographic data signal.

In addition, with the device according to the present invention, through one scan, even if the user changes to multiple sizes of image reading conditions, it can be set in a short time due to the inputting of the data for each of the multiple images that correspond to the multiple image sizes that are set in advance.

What is claimed is:

1. An image reading device for reading an image on a film, comprising:
photographic condition data input means for inputting photographic condition data taken at a time of photography on the film, and for outputting a photographic condition data signal;
image reading means for reading the image from the film; and
control means for determining reading conditions of the image reading means based upon the photographic condition data signal.

2. The image reading device according to claim 1, wherein the image reading means includes photoelectric conversion means for converting the image of the film to an electrical image signal, and the control means sets the exposure amount of the photoelectric conversion means.

3. The image reading device according to claim 1, wherein the image reading means includes photoelectric conversion means for converting the image of the film to an electrical image signal and process means for processing the image signal, wherein the control means sets a process of the process means.

4. The image reading device according to claim 3, wherein the process means comprises gradation means for converting gradation properties of the image signal.

5. The image reading device according to claim 1, wherein the control means controls the image reading means based upon the determined reading conditions.

6. The image reading device according to claim 1, wherein the photographic condition data is data regarding photograph size.

7. The image reading device according to claim 1, wherein the photographic condition data comprises exposure data from the time of photography.

8. The image reading device according to claim 1, wherein the photographic condition data input means inputs photographic condition data stored in a memory area of the film.

9. The image reading device according to claim 8, wherein the photographic condition data input means comprises a magnetic head that inputs photographic condition data stored in the memory area of the film.

10. The image reading device according to claim 1, wherein the photographic condition data input means receives data from a memory external to the film.

11. The image reading device according to claim 1, wherein the photographic condition data input means, at a first time of reading the image, inputs the photographic condition data occurring at the time of the photography of the film; and the control means drives the image reading means based upon the reading conditions set at a second time of reading the image.

12. The image reading device according to claim 11, wherein the control means, at the second time of reading the image, drives the image reading means based on the reading conditions that are set.

13. An image reading device for reading an image of a film, comprising:
a photographic condition data input device for inputting photographic condition data occurring at a time of photography of the film, and for outputting a photographic condition data signal;
image reading means for reading the image of the film, and, while the photographic condition data signal is output by the image reading means at the time of reading the image, for outputting optical density data; and
control means for setting reading conditions of the image reading means based on the photographic condition data signal and optical density data.

14. An image reading device for reading multiple images of a film, comprising:
image reading means for reading the images of the film; and
image data input means for inputting data for each of the images that corresponds to multiple image sizes that are pre-set through one scan.

15. The image reading device according to claim 14, further comprising:
selections for selecting one of the multiple image data; and
control means to set the reading conditions of the image reading means based on the image data selected by the selection means.

16. The image reading device according to claim 15, wherein the selection means selects one of the multiple image data in response to the operation of a user.

17. The image reading device according to claim 15, further comprising photographic condition data input means for inputting the image size data occurring at the time of photograph of the film, and for outputting the image size data signal, wherein the selection means selects one of the multiple image data based on the image size data signal.

18. The image reading device according to claim 14, further comprising control means for setting reading conditions of the image reading means based on one of the multiple image data.

19. A method for reading an image on a film, comprising the steps of:
inputting photographic condition data taken at a time of photography of the film;
outputting a photographic condition data signal;
reading the image from the
determining reading condition of image reading means based upon the photographic condition data signal.

20. The method according to claim 19, wherein said reading conditions comprising condition of converting the gradation properties of the image signal.

21. The method according to claim 19, wherein said inputting photographic condition data is stored in a memory area of the film.

22. The method according to claim 19, wherein said inputting photographic condition data is received from a memory external to the film.

23. The method according to claim 19, wherein, at a first time of reading the image, the photographic data occurring at the time of the photography of the film is input and the image reading means is driven based upon the reading conditions set at a second time of reading the image.

24. The method according to claim 23, wherein, at the second time of reading the image, the image reading means is driven based on the set reading conditions.

25. A method for reading an image of film, comprising the steps of:
inputting photographic data that occurs at a time of photography of the film;
outputting photographic data signal;
reading the image of the film;
outputting optical density data while the photographic data signal is output at the time of reading the image; and
setting reading conditions based on the photographic data signal and the optical density data.

26. A method for reading multiple images of a film, comprising the steps of:
reading the images of the film; and
inputting data for each of the multiple images that corresponds to multiple image sizes that are pre-set through one scan.

27. The method according to claim 26, further comprising setting reading conditions based on data of one of the multiple image sizes.

28. The method according to claim 27, wherein data of one of the multiple image sizes is selected in response to the operation of a user.

29. The method according to claim 27, further comprising:
inputting the image size data occurring at the time of photography of the film; and
outputting the image size data signal, wherein one of the multiple image data is selected based on the image size data signal.

30. The method according to claim 26, further comprising:
selecting one of the multiple image data; and
setting reading conditions based on the image data based on the selecting step.

31. An image reading device for reading an image on a film, comprising:
a photographic condition data input device that inputs photographic condition data taken at a time of photography on the film, and that outputs a photographic condition data signal;
an image reading device connected to the photographic condition data input device that reads the image from the film; and
a controller connected to the image reading device that determines reading conditions of the image reading device based upon the photographic condition data signal.

32. The image reading device according to claim 31, wherein the image reading device includes a photoelectric conversion device that converts the image of the film to an electrical image signal, and the controller sets the exposure amount of the photoelectric conversion device.

33. The image reading device according to claim 31, wherein the image reading device includes a photoelectric conversion device that converts the image of the film to an electrical image signal and a processor that processes the image signal, wherein the controller sets a process of the processor.

34. The image reading device according to claim 33, wherein the processor comprises a gradation device that converts gradation properties of the image signal.

35. The image reading device according to claim 31, wherein the controller controls the image reading device based upon the determined reading conditions.

36. The reading device according to claim 31, wherein the photographic condition data is data regarding photo a size.

37. The image reading device according to claim 31, wherein the photographic condition data comprises exposure data from the time of photography.

38. The image reading device according to claim 31, wherein the photographic condition data input device inputs photographic condition data stored in a memory area of the film.

39. The image reading device according to claim 38, wherein the photographic condition data input device comprises a magnetic head that inputs photographic condition data stored in the memory area of the film.

40. The image reading device according to claim 31, wherein the photographic condition data input device receives data from a memory external to the film.

41. The image reading device according to claim 31, wherein the photographic condition data input device, at a first tie of reading the image, inputs the photographic data occurring at the time of the photography of the film; and the controller drives the image reading device based upon the reading conditions set at a second time of reading the image.

42. The image reading device according to claim 41, wherein the controller, at the second time of reading the image, drives the image reading device based on the reading conditions that are set.

43. An image reading device for reading an image of a film, comprising:
a photographic condition data input device that inputs photographic condition data occurring at a time of photography of the film, and that outputs a photographic condition data signal;
an image reading device connected to the photographic condition data input device that reads the image of the film, and, while the photographic condition data signal is output by the image reading device at the time of reading the image, outputs optical density data; and
a controller connected to the image reading device that sets reading conditions of the image reading device based on the photographic condition data signal and the optical density data.

44. An image reading device for reading multiple images of a film, comprising:
an image reading device that reads the images of the film; and
an image data input device cooperable with the image reading device that inputs data for each of the images that corresponds to multiple image sizes that are pre-set through one scan.

45. The image reading device according to claim 44, further comprising:
a selection device that selects one of the multiple image data, and
a controller coupled to the selection device that sets the reading conditions of the image reading device based on the image data selected by the selection device.

46. The image reading device according to claim 45, wherein the selection device selects one of the multiple image data in response to the operation of a user.

47. The image reading device according to claim 45, further comprising a photographic condition data input device, coupled the selection device and the controller, that the image size data occurring at the time of photography of the film, and that outputs the image size data signal wherein the selection device selects one of the multiple image data based on the image size data signal.

48. The image reading device according to claim 44, further comprising a controller, coupled to the image reading device and the image data input device, that sets reading conditions of the image reading device based on one of the multiple image data.
